(19) United States
(12) Patent Application Publication
(10) Pub. No.: US 2016/0203749 A1
(43) Pub. Date: Jul. 14, 2016

(54) USING WAVELENGTH INFORMATION FOR AN AMBIENT LIGHT ENVIRONMENT TO ADJUST DISPLAY BRIGHTNESS AND CONTENT

(71) Applicants: AARON J. STEYSKAL, Portland, OR (US); SHELDON L. SUN, Portland, OR (US)

(72) Inventors: AARON J. STEYSKAL, Portland, OR (US); SHELDON L. SUN, Portland, OR (US)

(21) Appl. No.: 14/124,863

(22) PCT Filed: Sep. 27, 2013
(86) PCT No.: PCT/US2013/062091

§ 371 Date: Dec. 9, 2013

(51) Int. Cl. G09G 3/20

(52) U.S. Cl. CPC G09G 3/2007; G09G 2360/144; G09G 2330/021; G09G 2320/066

(57) ABSTRACT

Systems and methods may provide for receiving one or more signals from an ambient light sensor of a device and determining one or more wavelengths of an ambient light environment in which the device is located based on at least one of the one or more signals. Additionally, a display setting of the device may be adjusted based at least in part on the one or more wavelengths. In one example, the display setting includes one or more of a backlight brightness value, one or more pixel brightness values or one or more pixel color values.

### TECHNICAL FIELD

Embodiments generally relate to displays. More particularly, embodiments relate to the use of wavelength information for an ambient light environment to adjust display brightness and content.

### BACKGROUND

Handheld devices may use an ambient light sensor (ALS) to determine the brightness (e.g., illuminance, Lux) of the light in the ambient environment, wherein the brightness value may be used to adjust the display brightness of the device. For example, if the ALS reports a relatively high brightness value, the display brightness might be increased in order to achieve better visibility of the content shown on the display. If on the other hand, the ALS reports a relatively low brightness value, the display brightness may be decreased in order to conserve power and/or extend battery life (e.g., without concern over a negative impact on visibility).

Different types of light, however, may impact display visibility differently. For example, certain colors may be more visible on a display in sunlight than in fluorescent light for a given ambient brightness level, while other colors may be more visible in fluorescent light than in sunlight. Accordingly, conventional solutions that are limited to detecting ambient brightness may yield suboptimal display results from a visibility and/or power conservation perspective.

### BRIEF DESCRIPTION OF THE DRAWINGS

The various advantages of the embodiments will become apparent to one skilled in the art by reading the following specification and appended claims, and by referencing the following drawings, in which:

FIG. 1 is an illustration of an example of a device in different ambient light environments according to an embodiment;

FIG. 2 is a plot of an example of a set of relative energy curves for different types of light according to an embodiment;

FIG. 3 is a block diagram of an example of wavelength identification logic according to an embodiment;

FIG. 4 is a flowchart of an example of a method of Managing a device based on ambient light wavelength information according to an embodiment; and

FIG. 5 is block diagram of an example of a system according to an embodiment.

### DESCRIPTION OF EMBODIMENTS

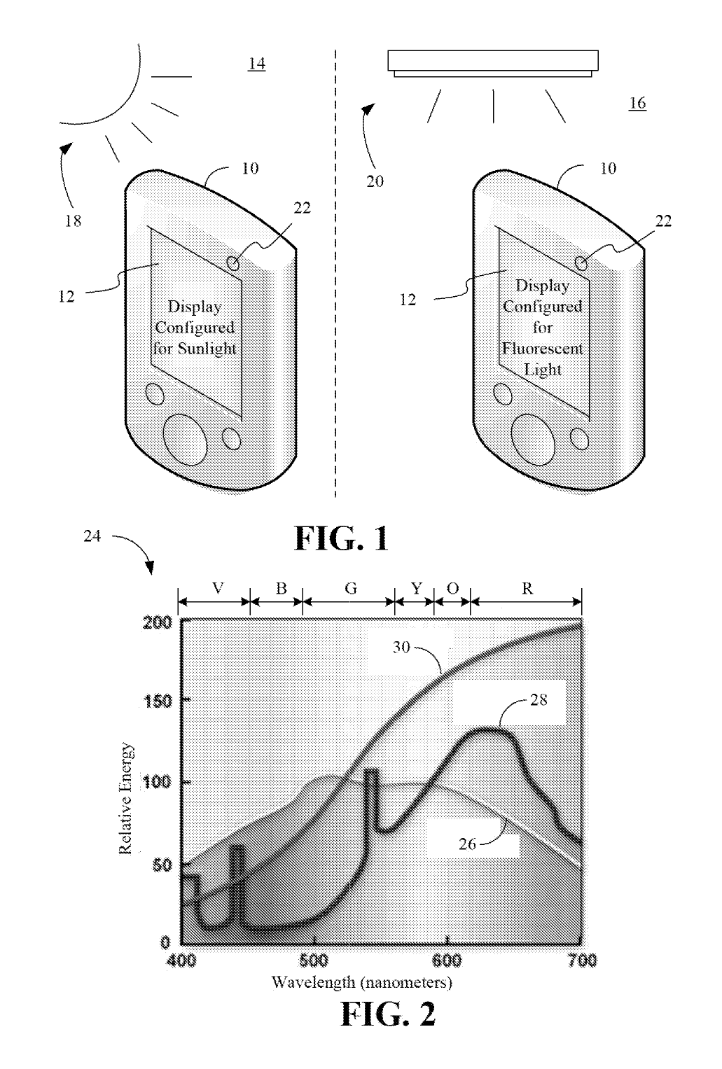

Turning now to FIG. 1, a device 10 is shown, wherein the illustrated device 10 has a display 12 that is able to automatically adapt to different ambient light environments. For example, in a first ambient light environment 14 that contains sunlight 18, the device 10 may configure the display 12 for the sunlight 18. In a second ambient light environment 16 containing fluorescent light 20, on the other hand, the illustrated device 10 configures the display 12 for the fluorescent light 20. As will be discussed in greater detail, the device 10 may include one or more ambient light sensors 22 that report wavelength information as well as brightness information for the environments 14, 16, wherein the wavelength and brightness information may be used to configure the display 12.

Moreover, configuring the display 12 may include setting the brightness of the display 12 (e.g., backlight intensity and/or pixel intensity), setting the pixel content of the display 12 (e.g., individual pixel color values), etc., based on the wavelength and brightness information to meet visibility (e.g., viewing experience) and/or power constraints. Additionally, the wavelength information may be used to control other aspects of the device 10 such as, for example, security settings, navigation settings, camera settings, and so forth. Thus, the illustrated approach may provide enhanced visibility of the display 12, longer battery life and improved performance in a wide variety of lighting environments.

Although only single ambient light sensor 22 is shown, the device may include multiple ambient light sensors. For example, a device with two ambient light sensors might use each one for different wavelength detection. In another example, one ambient light sensor may be disposed on the front of the device 10 and another ambient light sensor may be disposed on the back of the device 10 for more accurate readings. Other configurations may also be used.

FIG. 2 shows a plot 24 of a set of relative energy curves for different types of light. The plot 24 generally demonstrates that different types of light may have different wavelength and/or color content. In particular, a sunlight curve 26 may have greater amounts of green-yellow-orange light (e.g., 495-620 nm), whereas a fluorescent light curve 28 may contain peak amounts of violet light (e.g., 400 nm)., blue light (e.g., 450 nm), green light (e.g., 550 nm) and orange-red light (e.g., 610-660 nm). Additionally, a tungsten light curve 30 may have greater amounts of yellow-orange-red light (e.g., 570-700 nm). The curves 26, 28, 30 may vary depending upon the circumstances (e.g., cloud coverage, the type of fluorescent bulbs in use, etc.). Similar curves might be constructed for other types of light such as, for example, halogen lighting. Determining the wavelengths of the light detected from the ambient environment may enable devices such as the device 10 (FIG. 1) to optimize their displays from a visibility and/or power standpoint.

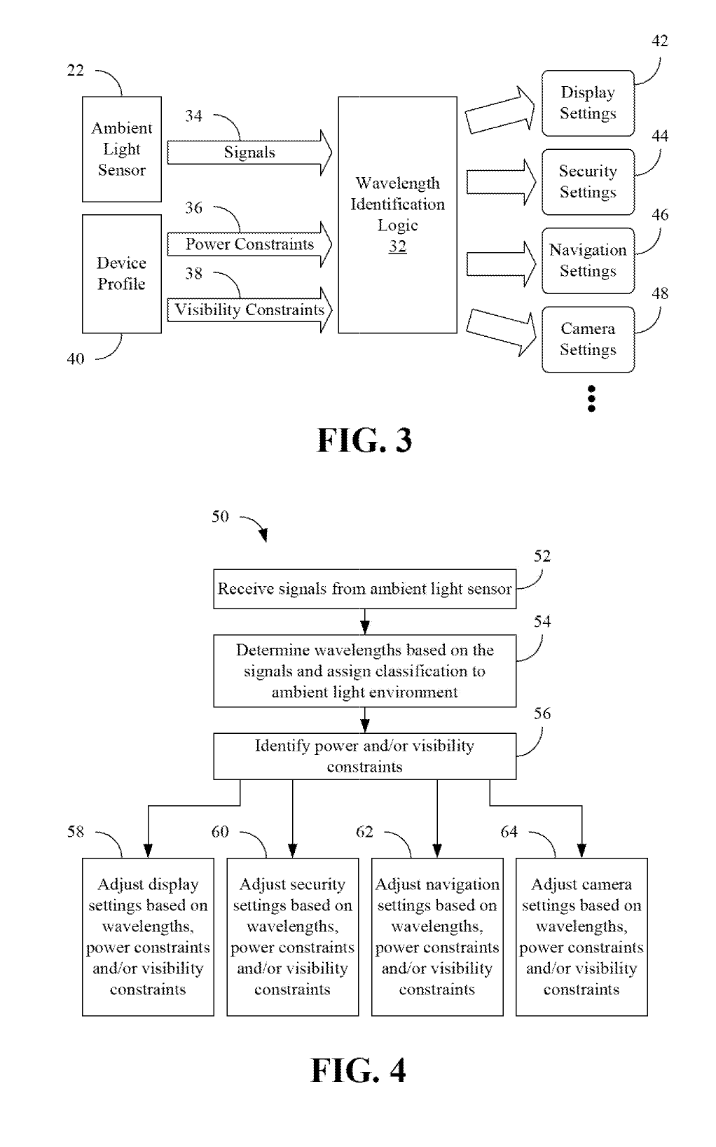

Turning now to FIG. 3, wavelength identification logic 2 is shown, wherein the logic 32 may receive one or more signals 34 from an ambient light sensor 22. The ambient light sensor (ALS) 22 may include a standard ALS, a red-green-blue (RGB) ALS, an RGB-clear/white (RGBC/W) ALS, an ultraviolet (UV) sensor, etc., or any combination therefore. Accordingly, the signals 34 may indicate the presence and amount of energy at one or more wavelengths in the visible light spectrum. The logic 32 may therefore be configured to determine one or more wavelengths of the ambient light environment in which the ALS 22 is located based on at least one of the one or more signals 34. In one example, the logic 32 assigns a type/classification (e.g., indoor lighting, outdoor lighting, sunlight, fluorescent lighting, halogen lighting, tungsten lighting, etc.) to the ambient light environment.

The illustrated logic 32 also receives one or more power constraints 36 and one or more visibility constraints 38 from a device profile 40 or other suitable source of constraint information. The power constraints 36 may include, for example, variable or fixed power consumption targets and/or thresholds that the logic 32 may use to achieve a certain battery life or other power related condition. The visibility constraints 38 may include, for example, variable or fixed visual targets and/or thresholds that the logic 32 may used to achieve a certain image quality or other visual condition. The power constraints 36 and the visibility constraints 38 may be user configurable, default values, etc., or any combination thereof.

The illustrated logic 32 adjusts one or more display settings 42 associated with a display based at least in part on the one or more wavelengths. The display settings 42 might include, for example, backlight brightness values, pixel brightness values (e.g., for organic light emitting diode/OLED displays), pixel color values, and so forth. Thus, for example, if the signals 34 indicate that the ambient light environment contains relatively bright fluorescent lighting, the logic 32 may increase the brightness of pixels containing violet, blue, green and/or orange-red content in accordance with the fluorescent light curve (FIG. 2) to increase visibility of those pixels. Alternatively, the logic 32 could also reduce the brightness of violet, blue, green and/or orange-red pixels in order to save power if the signals 34 indicate that the ambient light environment contains relatively dim fluorescent lighting.

If on the other hand, the signals 34 indicate that the ambient light environment contains relatively bright tungsten lighting, the logic 32 might increase the brightness of pixels containing yellow-orange-red light in accordance with the tungsten light curve 30 (FIG. 2) to increase visibility. Alternatively, the logic 32 may also reduce the brightness of yellow-orange-red pixels to save power if the signals 34 indicate that the ambient light environment contains relatively dim tungsten lighting.

The logic 32 may also change the color content of the pixels to balance the displayed image. For example, if the signals 34 indicate that the ambient light environment contains relatively bright sunlight, the logic may increase the violet-blue and red pixel content in accordance with the sunlight curve 26 (FIG. 2) to prevent the green-yellow-orange pixel content from dominating the image. The specific colors and/or wavelength ranges given are to facilitate discussion only.

The logic 32 may also adjust one or more security settings 44 of the device based at least on part on the one or more wavelengths. For example, one or more features of the device may be deactivated (e.g., all features other than emergency calling) if it is determined from the wavelengths that the device is in a relatively insecure location (e.g., outdoors versus indoors). Similarly, one or more features of the device may be activated if it is determined from the wavelengths that the device is in a relatively secure location (e.g., indoors versus outdoors). Indeed, the wavelength information may be used to identify “wavelength signatures” for specific locations such as, for example, work office, home office, bedroom, etc., wherein the security of the device might be relaxed in designated areas having a particular wavelength signature.

The illustrated logic 32 also adjusts one or more navigation settings 46 of the device based at least in part on the one or more wavelengths. For example, a distinction may be made between indoor navigation and outdoor navigation, wherein features such as, for example, map resolution, prompts (e.g., audible versus visual), may vary accordingly.

In addition, the logic 32 may adjust one or more camera settings 48 of the device based at least in part on the one or more wavelengths. For example, if it is determined from the wavelengths that the device is exposed to sunlight, the color balance of the camera may be adjusted to increase the violet-blue and red pixel content of the captured image to balance that content against the green-yellow-orange content of the image. Other device settings may also be adjusted based on the wavelength information.

Turning now to FIG. 4, a method 50 of managing a device is shown. The method 50 may be implemented as a set of logic instructions stored in a machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality hardware logic using circuit technology such as, for example, application specific integrated circuit (ASIC), complementary metal oxide semiconductor (CMOS) or transistor-transistor logic (TTL) technology, or any combination thereof. For example, computer program code to carry out operations shown in method 50 may be written in any combination of one or more programming languages, including an object oriented programming language such as Java, Smalltalk, C++ or the like and conventional procedural programming languages, such as the “C” programming language or similar programming languages. In one example, the method 50 is implemented as the wavelength identification logic 32 (FIG. 3), already discussed.

Illustrated processing block 52 provides for receiving one or more signals from an ambient light sensor of a device, wherein one or more wavelengths of an ambient light environment in which the device is located may be determined at block 54 based on at least one of the one or more signals. Block 54 may also provide for assigning a classification to the ambient light environment based at least in part on the one or more wavelengths. The classification might include, for example, indoor lighting, outdoor lighting, sunlight, fluorescent lighting, halogen lighting, tungsten lighting, and so forth.

Illustrated block 56 identifies one or more power and/or visibility constraints, wherein one or more display settings of the display may be adjusted at block 58 based at least in part on the one or more wavelengths, the power constraints and/or the visibility constraints. As already noted, adjusting the display settings might including adjusting a backlight brightness value, one or more pixel brightness values and/or one or more pixel color values.

One or more security settings of the display may be adjusted at block 60 based at least in part on the one or more wavelengths, the power constraints and/or the visibility constraints. Adjusting the security settings may involve activating and/or deactivating one or more features of the device, increasing and or decreasing the credential requirements of the device, and so forth.

Illustrated block 62 adjusts one or more navigation settings of the device based at least in part on the one or more wavelengths, the power constraints and/or the visibility constraints. The navigation settings might include, for example, map resolution, prompts (e.g., audio versus visual), and so forth.

Additionally, block 64 may adjust one or more camera settings based at least in part on the one or more wavelengths, the power constraints and: or the visibility constraints. Block 64 might involve adjusting, for example, the color balance, flash configuration, shutter speed, and so forth.

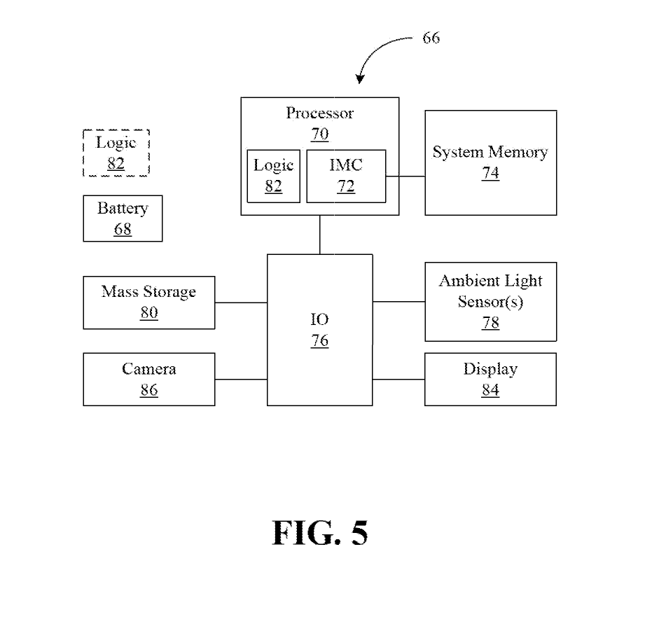

FIG. 5 shows a system 66. The system 66 may be part of a platform having computing functionality (e.g., personal digital assistant/FDA, desktop computer, laptop, tablet computer, convertible tablet), communications functionality wireless smart phone), imaging functionality, media playing functionality (e.g., smart television/TV), or any combination thereof (e.g., mobile Internet device/MID). In the illustrated example, the system 66 includes a battery 68 to supply power to the system 66 and a processor 70 having an integrated memory controller (IMC) 72, which may communicate with system memory 74. The system memory 74 may include, for example, dynamic random access memory (DRAM) configured as one or more memory modules such as, for example, dual inline memory modules (DIMMs), small outline DIMMs (SODIMMs), etc.

The illustrated system 66 also includes a input output (IO) module 76, sometimes referred to as a Southbridge of a chipset, that functions as a host device and may communicate with, for example, a display 84 (e.g., (SLED display, liquid crystal display/LCD, etc.), a camera 86, one or more ambient light sensors 78 (e.g., standard ALS, RGB ALS, RGBC/W ALS, etc.) and mass storage 80 (e.g., hard disk drive/HDD, optical disk, flash memory, etc.). The processor 70 may execute one or more imaging, navigation and/or security applications (not shown).

The illustrated processor 70 may also execute logic 82 that is configured to receive one or more signals from the ambient light sensors 78, determine one or more wavelengths of an ambient light environment in which the system 66 is located based on at least one of the one or more signals and adjust a display setting associated with the display 84 based at least in part on the one or more wavelengths. Thus, the illustrated logic 82 may function similarly to the wavelength identification logic 32 (FIG. 3), already discussed.

The logic 82 may also adjust a security setting of the system 66, a camera setting of the camera 86 and/or a navigation setting of the system 66 based at least in part on the one or more wavelengths. In one example, the adjustments also take into consideration one or more power constraints and/or visibility constraints. The logic 82 may alternatively be implemented external to the processor 70. Additionally, the processor 70 and the IO module 76 may be implemented together on the same semiconductor die as a system on chip (SoC).

### ADDITIONAL NOTES AND EXAMPLES

Example 1 may include a device comprising an ambient light sensor, a battery to supply power to the device, a display and logic, implemented at least partly in fixed-functionality hardware. The logic may determine one or more wavelengths of an ambient light environment in which the device is located based on at least one of one or more signals from the ambient light sensor, and adjust a display setting associated with the display based at least in part on the one or more wavelengths.

Example 2 may include the device of Example 1, wherein the display setting is to include one or more of a backlight brightness value, one or more pixel brightness values or one or more pixel color values.

Example 3 may include the device of Example 1, wherein the display setting is to be adjusted further based on a power constraint.

Example 4 may include the device of Example 1, wherein the display setting is to be adjusted further based on a visibility constraint.

Example 5 may include the device of any one of Examples 1 to 4, wherein the logic is to adjust one or more of a security setting, a camera setting or a navigation setting of the device based at least in part on the one or more wavelengths.

Example 6 may include the device of Example 1, wherein the logic is to assign a classification to the ambient light environment based at least in part on the one or more wavelengths, and wherein the classification includes one or more of indoor lighting, outdoor lighting, sunlight, fluorescent lighting, halogen lighting or tungsten lighting.

Example 7 may include a method of managing a device, comprising determining one or more wavelengths of an ambient light environment in which a device is located based on at least one of one or more signals from an ambient light sensor and adjusting a display setting of the device based at least in part on the one or more wavelengths.

Example 8 may include the method of Example 7, wherein the display setting includes one or more of a backlight brightness value, one or more pixel brightness values or one or more pixel color values.

Example 9 may include the method of Example 7, wherein the display setting is adjusted further based on a power constraint.

Example 10 may include the method of Example 7, wherein the display setting is adjusted further based on a visibility constraint.

Example 11 may include the method of any one of Examples 7 to 10, further including adjusting one or more of a security setting, a camera setting or a navigation setting of the device based at least in part on the one or more wavelengths.

Example 12 may include the method of Example 7, further including assigning a classification to the ambient light environment based at least in part on the one or more wavelengths, wherein the classification includes one or more of indoor lighting, outdoor lighting, sunlight, fluorescent lighting, halogen lighting or tungsten lighting.

Example 13 may include an apparatus comprising logic, implemented at least partly in fixed-functionality hardware, to determine one or more wavelengths of an ambient light environment in which a device is located based on at least one of one or more signals, and adjust a display setting of the device based at least in part on the one or more wavelengths.

Example 14 may include the apparatus of Example 13, wherein the display setting is to include one or inure of a backlight brightness value, one or inure pixel brightness values or one or more pixel color values.

Example 15 may include the apparatus of Example 13, wherein the display setting is to be adjusted further based on a power constraint.

Example 16 may include the apparatus of Example 13, wherein the display setting is to be adjusted further based on a visibility constraint.

Example 17 may include the apparatus of any one of Examples 13 to 16, wherein the logic is to adjust one or more of a security setting, a camera setting or a navigation setting of the device based at least in part on the one or more wavelengths.

Example 18 may include the apparatus of Example 13, wherein the logic is to assign a classification to the ambient light environment based at least in part on the one or more wavelengths, and wherein the classification includes one or more of indoor lighting, outdoor lighting, sunlight, fluorescent lighting, halogen lighting or tungsten lighting.

Example 19 may include at least one non-transitory computer readable storage medium comprising a set of instructions which, if executed by a device, cause the device to determine one or more wavelengths of an ambient light environment in which the device is located based on at least one of one or more signals, and adjust a display setting of the device based at least in part on the one or more wavelengths.

Example 20 may include the at least one computer readable storage medium of Example 19, wherein the display setting is to include one or more of a backlight brightness value, one or more pixel brightness values or one or more pixel color values.

Example 21 may include the at least one computer readable storage medium of Example 19, wherein the display setting is to be adjusted further based on a power constraint.

Example 22 may include the at least one computer readable storage medium of Example 19, wherein the display setting is to be adjusted further based on a visibility constraint.

Example 23 may include the at least one computer readable storage medium of any one of Examples 19 to 22, wherein the instructions, if executed, cause the device to adjust one or more of a security setting, a camera setting or a navigation setting of the device based at least in part on the one or more wavelengths.

Example 24 may include the at least one computer readable storage medium of Example 19, wherein the instructions, if executed, cause the device to assign a classification to the ambient light environment based at least in part on the one or more wavelengths, and wherein the classification includes one or more of indoor lighting, outdoor lighting, sunlight, fluorescent lighting, halogen lighting or tungsten lighting.

Example 25 may include an apparatus to manage display settings, comprising means for performing the method of any one of examples 7 to 12.

Thus, techniques described herein may enable a better understanding of ambient lighting conditions to be achieved based on wavelength information. This enhanced understanding may lead to improved visibility and/or battery life. Additionally, proper color reproduction may be ensured in a wide variety of lighting conditions. Moreover, the techniques may further enhance security, navigation and/or camera performance.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

1-24. (canceled)

25. A device comprising:
an ambient light sensor;
a battery to supply power to the device;
a display; and
logic, implemented at least partly in fixed-functionality hardware, to:
determine one or more wavelengths of an ambient light environment in which the device is located based on at least one of one or more signals from the ambient light sensor, and
adjust a display setting associated with the display based at least in part on the one or more wavelengths.

26. The device of claim 25, wherein the display setting is to include one or more of a backlight brightness value, one or more pixel brightness values or one or more pixel color values.

27. The device of claim 25, wherein the display setting is to be adjusted further based on a power constraint.

28. The device of claim 25, wherein the display setting is to be adjusted further based on a visibility constraint.

29. The device of claim 25, wherein the logic is to adjust one or more of a security setting, a camera setting or a navigation setting of the device based at least in part on the one or more wavelengths.

30. The device of claim 25, wherein the logic is to assign a classification to the ambient light environment based at least in part on the one or more wavelengths, and wherein the classification includes one or more of indoor lighting, outdoor lighting, sunlight, fluorescent lighting, halogen lighting or tungsten lighting.

31. A method comprising:
determining one or more wavelengths of an ambient light environment in which a device is located based on at least one of one or more signals from an ambient light sensor; and
adjusting a display setting of the device based at least in part on the one or more wavelengths.

32. The method of claim 31, wherein the display setting includes one or more of a backlight brightness value, one or more pixel brightness values or one or more pixel color values.

33. The method of claim 31, wherein the display setting is adjusted further based on a power constraint.

34. The method of claim 31, wherein the display setting is adjusted further based on a visibility constraint.

35. The method of claim 31, further including adjusting one or more of a security setting, a camera setting or a navigation setting of the device based at least in part on the one or more wavelengths.

36. The method of claim 31, further including assigning a classification to the ambient light environment based at least in part on the one or more wavelengths, wherein the classification includes one or more of indoor lighting, outdoor lighting, sunlight, fluorescent lighting, halogen lighting or tungsten lighting.

37. An apparatus comprising:
logic, implemented at least partly in fixed-functionality hardware, to:
determine one or more wavelengths of an ambient light environment in which a device is located based on at least one of one or more signals from an ambient light sensor, and
adjust a display setting of the device based at least in part on the one or more wavelengths.

38. The apparatus of claim 37, wherein the display setting is to include one or more of a backlight brightness value, one or more pixel brightness values or one or more pixel color values.

39. The apparatus of claim 37, wherein the display setting is to be adjusted further based on a power constraint.

40. The apparatus of claim 37, wherein the display setting is to be adjusted further based on a visibility constraint.

41. The apparatus of claim 37, wherein the logic is to adjust one or more of a security setting, a camera setting or a navigation setting of the device based at least in part on the one or more wavelengths.

42. The apparatus of claim 37, wherein the logic is to assign a classification to the ambient light environment based at least in part on the one or more wavelengths, and wherein the classification includes one or more of indoor lighting, outdoor lighting, sunlight, fluorescent lighting, halogen lighting or tungsten lighting.

43. At least one non-transitory computer readable storage medium comprising a set of instructions which, if executed by a device, cause the device to:
determine one or more wavelengths of an ambient light environment in which the device is located based on at least one of one or more signals from an ambient light sensor; and
adjust a display setting of the device based at least in part on the one or more wavelengths.

44. The at least one computer readable storage medium of claim 43, wherein the display setting is to include one or more of a backlight brightness value, one or more pixel brightness values or one or more pixel color values.

45. The at least one computer readable storage medium of claim 43, wherein the display setting is to be adjusted further based on a power constraint.

46. The at least one computer readable storage medium of claim 43, wherein the display setting is to be adjusted further based on a visibility constraint.

47. The at least one computer readable storage medium of claim 43, wherein the instructions, if executed, cause the device to adjust one or more of a security setting, a camera setting or a navigation setting of the device based at least in part on the one or more wavelengths.

48. The at least one computer readable storage medium of claim 43, wherein the instructions, if executed, cause the device to assign a classification to the ambient light environment based at least in part on the one or more wavelengths, and wherein the classification includes one or more of indoor lighting, outdoor lighting, sunlight, fluorescent lighting, halogen lighting or tungsten lighting.
